(19) United States
(12) Patent Application Publication
(10) Pub. No.: US 2026/0195613 A1
(43) Pub. Date: Jul. 9, 2026

(54) INTELLIGENT ASSISTANT SYSTEM AND METHOD FOR SUPPORTING SOCIAL MEDIA CONVERSATIONS

(71) Applicant: Charles Lap San CHAN, Taipei (TW)

(72) Inventor: Charles Lap San CHAN, Taipei (TW)

(21) Appl. No.: 19/440,370

(22) Filed: Jan. 5, 2026

(30) Foreign Application Priority Data
Jan. 7, 2025 (TW) 114100582

(51) Int. Cl. G06N 5/022

(52) U.S. Cl. CPC G06N 5/022

(57) ABSTRACT

An intelligent assistant system and method for supporting social media conversations are provided. The system receives text messages from a social media platform via a dialogue recording module, utilizes natural language processing technology, segments the message content into a plurality of semantic units by a content processing module, and converts them into a new knowledge graph. The system has a knowledge graph database to store a pre-loaded knowledge graph and the new knowledge graph. A knowledge retrieval module queries the pre-loaded knowledge graph based on the semantic units to obtain a relevant knowledge graph, and a reference data module generates a reference data message having a correlation based on the relevant knowledge graph. The disclosure can assist users in obtaining, in social media conversations, relevant reference information, at least one of a relevant information hint, suggested response content, or a historical relevant message, to improve communication efficiency.

### CROSS-REFERENCE TO RELATED APPLICATION

This application claims the priority benefit of Taiwan application No. 114100582, filed on Jan. 7, 2025. The entirety of the above-mentioned patent application is hereby incorporated by reference herein and made a part of this specification.

### BACKGROUND OF THE INVENTION

### Field Of The Invention

The disclosure relates to an intelligent assistant system and method, and more particularly, to an intelligent assistant system and method for supporting social media conversations.

### Description of the Related Art

In recent years, with the popularity of social media software, the conversation content and conversation time of users on social media platforms have become increasingly rich. In order to assist users in obtaining a better interaction experience in social media conversations, various intelligent assistant systems have emerged.

Traditional intelligent assistant systems typically employ keyword matching or rule-based methods to process user input. Although such systems can identify simple commands or queries, they often fail to provide accurate responses for complex conversation content, especially in cases where context needs to be considered.

On the other hand, traditional systems also face challenges in knowledge updating and maintenance. These systems usually store knowledge in a fixed data structure, but when the system receives new conversation content, how to effectively integrate new knowledge into the existing knowledge database and ensure the consistency and usability of knowledge remains a problem to be solved.

Therefore, developing a system and method that can overcome the aforementioned drawbacks, provide users with convenient reference data messages, and effectively expand and update the content of the knowledge database is of great necessity.

### SUMMARY OF THE INVENTION

An objective of the disclosure is to provide an intelligent assistant system and method for supporting social media conversations, capable of providing users with convenient reference data messages.

Another objective of the disclosure is to provide an intelligent assistant system and method for supporting social media conversations, capable of effectively expanding and updating the content of a knowledge database.

To achieve the above objectives, the disclosure provides an intelligent assistant system for supporting social media conversations, comprising:
a dialogue recording module, configured to receive text messages from a social media platform, wherein the text message includes a transmission timestamp, a sender identifier, and message content;
a content processing module, configured to segment the message content into a plurality of semantic units and convert the plurality of semantic units into a new knowledge graph;
a knowledge graph database, configured to store a pre-loaded knowledge graph and the new knowledge graph;
a knowledge retrieval module, configured to query the pre-loaded knowledge graph in the knowledge graph database based on the plurality of semantic units to obtain a relevant knowledge graph; and
a reference data module, configured to generate a reference data message based on the relevant knowledge graph, wherein the reference data message has a correlation with the message content.

The disclosure provides a method for supporting social media conversations, comprising the following steps:
receiving text messages from a social media platform, wherein the text message includes a transmission timestamp, a sender identifier, and message content;
segmenting the message content to obtain a plurality of semantic units, and converting the plurality of semantic units into a new knowledge graph;
storing the new knowledge graph into a knowledge graph database, wherein the knowledge graph database further has a pre-loaded knowledge graph;
querying the pre-loaded knowledge graph in the knowledge graph database based on the plurality of semantic units to obtain a relevant knowledge graph; and
generating a reference data message based on the relevant knowledge graph, wherein the reference data message has a correlation with the message content.

The features, advantages, or similar expressions mentioned in this specification do not imply that all features and advantages that can be realized by the disclosure should be within any single specific embodiment of the disclosure. Rather, it should be understood that the expression regarding features and advantages refers to that specific features, advantages, or characteristics described in conjunction with specific embodiments are included in at least one specific embodiment of the disclosure. Therefore, the discussion of features and advantages, and similar expressions in this specification relates to the same specific embodiment, but it is not necessary.

The features and advantages of the disclosure can be further understood by referring to the following description and the appended claims or by utilizing the embodiments of the disclosure mentioned below.

### BRIEF DESCRIPTION OF THE DRAWINGS

FIG. 1 is a system block diagram of an intelligent assistant system for supporting social media conversations according to a preferred embodiment of the disclosure.

FIG. 2 is a flowchart of a method for supporting social media conversations according to a preferred embodiment of the disclosure.

### DETAILED DESCRIPTION OF THE INVENTION

To make the description of the present disclosure more detailed and complete, the following provides illustrative descriptions of the implementation aspects and specific embodiments of the present case; however, this is not the only form for implementing or applying the specific embodiments of the disclosure. The detailed description covers features of multiple specific embodiments as well as the method steps and their sequence for constructing and operating these specific embodiments. However, other specific embodiments may also be utilized to achieve the same or equivalent functions and step sequences.

The disclosure proposes an intelligent assistant system and method for supporting social media conversations, the primary objective of which is to solve the problem in existing social media platforms where users lack immediate and relevant reference information support during conversations. The disclosure utilizes natural language processing and knowledge graph technologies to automatically analyze conversation content and provide reference data messages highly relevant to the conversation topic, enabling users to obtain more complete information support when conducting discussions, making decisions, or solving problems. In addition, the intelligent assistant system of the disclosure has self-learning characteristics, capable of continuously capturing new knowledge from users'daily conversations and integrating this new knowledge into the system's knowledge graph database through a periodic update mechanism, thereby continuously expanding and optimizing the system's knowledge base. This dynamic update characteristic allows the system to adapt to professional terminology and knowledge structures in different fields, and evolve with user usage habits and needs, providing intelligent assistance services that better meet user needs.

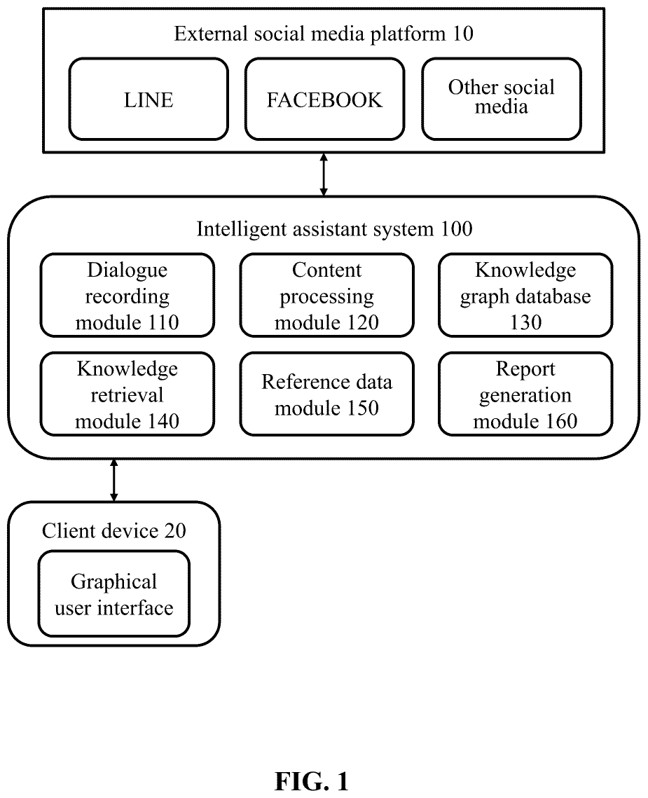

Referring to FIG. 1, a system block diagram of an intelligent assistant system for supporting social media conversations according to the disclosure is shown. The intelligent assistant system 100 comprises: a dialogue recording module 110, a content processing module 120, a knowledge graph database 130, a knowledge retrieval module 140, a reference data module 150, and a report generation module 160. The intelligent assistant system 100 is also connected to an external social media platform 10 and a client device 20.

The dialogue recording module 110 may establish a connection with the social media platform via an Application Programming Interface (API). In practical applications, the social media platform may be instant messaging software such as LINE, WhatsApp, Facebook Messenger, or work collaboration platforms such as Slack, Microsoft Teams, but the disclosure is not limited thereto. The dialogue recording module 110 is configured to receive text messages from the social media platform, wherein the text message includes a transmission timestamp, a sender identifier (sender ID), and message content. The dialogue recording module 110 may receive these text messages in real-time or retrieve historical messages in batches periodically.

The content processing module 120 is responsible for performing natural language processing on the received message content. Specifically, the content processing module 120 may, for example, use methods such as word segmentation and syntactic parsing to segment the message content into a plurality of semantic units having complete semantics. Next, the content processing module 120 uses techniques such as named entity recognition and relation extraction to convert these semantic units into a new knowledge graph having a node and relation structure.

The knowledge graph database 130 is configured to store the knowledge base of the intelligent assistant system 100, including a pre-loaded knowledge graph and the new knowledge graph. The pre-loaded knowledge graph may include knowledge structures pre-defined by domain experts, such as professional terminology and concept relationships in specific industries, but is not limited thereto. The new knowledge graph is derived from text messages of user conversation content on the social media platform. The intelligent assistant system 100 periodically updates and merges the new knowledge graph into the pre-loaded knowledge graph, thereby continuously expanding and optimizing the system's knowledge base.

The knowledge retrieval module 140 is responsible for retrieving relevant information in the knowledge graph database 130. Specifically, the knowledge retrieval module 140 queries relevant knowledge in the pre-loaded knowledge graph based on the semantic units generated by the content processing module 120, employing algorithms such as graph matching and semantic similarity calculation, and outputs the query result as a relevant knowledge graph.

The reference data module 150 generates a reference data message based on the relevant knowledge graph output by the knowledge retrieval module 140. In implementation, the reference data module 150 analyzes node content and relation types between nodes in the relevant knowledge graph, and applies them to a pre-defined response text template to generate a reference data message containing relevant information hints, suggested response content, or historical relevant messages. The correlation between these reference data messages and the original message content can be determined by comparing node content similarity or node relation type similarity in the knowledge graph. In one embodiment, the reference data message output by the reference data module 150 can be displayed on a graphical user interface within the client device 20 operated by the user for user reference.

The report generation module 160 provides a function of converting the new knowledge graph into a user-readable text report. In practical applications, the report generation module 160 may use natural language generation technology to convert the knowledge structure of the new knowledge graph into coherent text descriptions, so that the user can understand and analyze the knowledge context in the conversation content. Similarly, the text report generated by the report generation module 160 can be displayed on a graphical user interface within the client device 20 operated by the user for user reference.

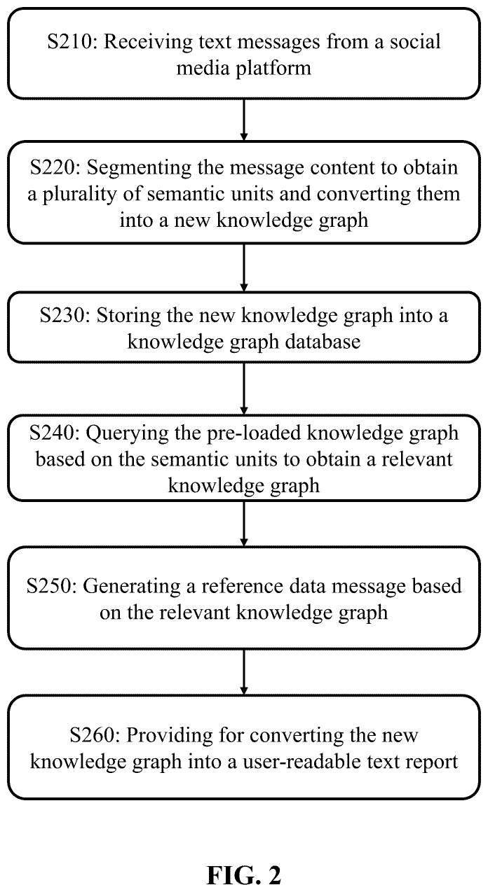

Referring to FIG. 2, a flowchart of a method for supporting social media conversations according to the disclosure is shown. The method comprises the following steps:
Step S210: Receiving text messages from a social media platform. The system establishes a connection with the social media platform via an Application Programming Interface (API) and receives text messages including transmission timestamps, sender identifiers, and message content.

Step S220: Segmenting the message content to obtain a plurality of semantic units and converting them into a new knowledge graph. The system uses natural language processing technologies, such as word segmentation and syntactic parsing, to segment the message content into units with complete semantics, and converts these semantic units into nodes and relations of a new knowledge graph.

Step S230: Storing the new knowledge graph into a knowledge graph database. The system stores the converted new knowledge graph into a database, which has pre-stored a pre-loaded knowledge graph. The system periodically updates the new knowledge graph to the pre-loaded knowledge graph to expand the content of the pre-loaded knowledge graph.

Step S240: Querying the pre-loaded knowledge graph based on the semantic units to obtain a relevant knowledge graph. For example, algorithms such as graph matching and semantic similarity calculation can be employed to retrieve relevant knowledge in the pre-loaded knowledge graph based on the semantic units to obtain a relevant knowledge graph.

Step S250: Generating a reference data message based on the relevant knowledge graph. The system analyzes node content and node relation types in the relevant knowledge graph, applies a response text template, and generates a reference data message having a correlation with the original message content.

Step S260: Providing for converting the new knowledge graph into a user-readable text report. In one embodiment of the disclosure, natural language generation technology may be used to convert the knowledge structure of the new knowledge graph into coherent text descriptions and output a text report, so that the user can understand and analyze the knowledge context in the conversation content.

Two specific embodiments are provided below to illustrate the practical application of the disclosure:

### Embodiment 1: Technical Support Scenario

In a technical support group of a technology company:
Message Reception (Step S210): The system receives the following message:
Timestamp: 2024-12-27 14:30:25
Sender ID: support_user_123
Message Content: “Encountered memory insufficiency problem during system deployment. Currently using a 4GB RAM instance. How to evaluate whether to expand memory?”
Semantic Analysis (Step S220): The system segments the message into semantic units, including as follows:
Entities: {“System”, “Memory”, “RAM”, “Instance”}
Actions: {“Deployment”, “Evaluate”, “Expand”}
Attributes: {“Insufficiency”}
Values: {“4GB”}

The above semantic units are then converted into a new knowledge graph, which will contain nodes and relations.

### Knowledge Graph Storage and Update (Step S230):

Storing the new knowledge graph to the knowledge graph database. For example, the system may perform a knowledge graph update once a week, integrating common problems and solutions from recent discussions into the pre-loaded knowledge graph.

Update Case: This week accumulated 15 relevant memory management discussions. The system organizes these discussions into standardized problem-solution patterns and updates them to the pre-loaded knowledge graph.

Knowledge Retrieval (Step S240): The system queries the pre-loaded knowledge graph to find knowledge related to memory evaluation therein, for example, finding content including: memory usage evaluation methods, handling experience of similar cases, and best practice suggestions.

Reference Data Generation (Step S250): The system generates a reference data message, for example: “It is suggested to take the following steps to evaluate memory requirements: use the top command to monitor memory usage, check swap usage, and then analyze application memory leak risks. Historical cases show: similar Web applications are suggested to reserve at least 50% memory buffer.”

In addition, the method of the disclosure may further comprise report generation (Step S260). The report generation module 160 of the disclosure can provide for converting the new knowledge graph into a user-readable text report. For example, in this example, the system may generate a monthly technical support knowledge summary report, referenced as follows:

### December Technical Support Knowledge Report

### Distribution of Main Problem Types:

Memory related: 35%
Network configuration: 28%
Security issues: 22%
Others: 15%

### Knowledge Base Update Statistics:

New solutions: 45 items
Optimized existing solutions: 23 items
Knowledge coverage improvement: 12%

### Key Improvement Suggestions:

1.Strengthen memory management best practice documentation
2.Establish standardized resource evaluation processes

### Embodiment 2: Product Development Scenario

In a discussion group of a product development team:

Message Reception (Step S210): The system receives the following message:
Timestamp: 2024-12-27 15:45:10
Sender ID: pm_456
Message Content: “The new version needs to add a face recognition function. Need to evaluate whether to use OpenCV or TensorFlow solution. Does anyone have suggestions?”

Semantic Analysis (Step S220): The system segments the message into semantic units, including as follows:
Entities: {“New version”, “Face recognition”, “OpenCV”, “TensorFlow”, “Solution”}
Actions: {“Add”, “Evaluate”, “Use”}
Attributes: {“Functionality”}
Values: None

### Knowledge Graph Storage and Update (Step S230):

The semantic units obtained from the discussion content are then converted into a new knowledge graph and stored to the pre-loaded knowledge graph, for example, performing an integrated update of technical knowledge every two weeks.

Knowledge Retrieval (Step S240): The system queries the pre-loaded knowledge graph to find relevant technical evaluation information, including: comparison of the two technical solutions, actual application cases, and performance test data.

Reference Data Generation (Step S250): The system generates a reference data message, for example: “Based on historical project experience, OpenCV advantages can be evaluated: lower resource consumption, suitable for embedded devices, simple deployment; TensorFlow advantages: higher recognition accuracy, supports more deep learning models, better scalability.”

Similarly, this embodiment may also comprise report generation (Step S260). For example, the system tracks the discussions during the entire process of the product development team, and finally generates a technical decision tracking report as follows:

### Technology Selection Analysis Report

Discussion Topic: Face Recognition Technology Selection
Participating Members: 8 people
Discussion Duration: 3 days
Decision Process Tracking:
   1. Requirement Analysis
   Accuracy requirement: >95%
   Execution performance: <100 ms/frame
   Deployment environment: Edge devices
   2. Solution Evaluation
   OpenCV score: 78 points
   TensorFlow score: 92 points
   3. Final Resolution
   Adopt TensorFlow solution
   Reason: Accuracy and scalability considerations
Follow-up Action Items:
   1. Establish PoC verification environment
   2. Conduct performance benchmark testing

From the above description, it can be seen that the intelligent assistant system and method for supporting social media conversations proposed by the disclosure can automatically analyze conversation content through natural language processing and knowledge graph technologies, and provide reference data messages highly relevant to the conversation topic, enabling users to obtain more complete information support when conducting discussions, making decisions, or solving problems. Moreover, the intelligent assistant system of the disclosure has self-learning characteristics, capable of continuously capturing new knowledge from users'daily conversations and integrating this new knowledge into the system's knowledge graph database through a periodic update mechanism, thereby continuously expanding and optimizing the system's knowledge base.

While various examples of the disclosed technology have been described above, it should be understood that these examples have been presented by way of example only, and not limitation. Likewise, the various diagrams may depict example architectures or other configurations for the disclosed technology, which are provided to aid in understanding the features and functionality that can be included in the disclosed technology. The disclosed technology is not limited to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Additionally, with regard to flowcharts, operational descriptions, and method claims, the order in which the steps are presented herein should not require that the disclosed technology be implemented to perform the recited functionality in the same order, unless the context dictates otherwise.

The foregoing description is merely of the preferred embodiments of the disclosure and is not intended to limit the scope of implementation of the disclosure. Accordingly, all equivalent changes and modifications made in accordance with the shape, structure, features, and spirit described in the claims of the disclosure should be included within the scope of the claims of the disclosure.

What is claimed is:

1. An intelligent assistant system for supporting social media conversations, comprising:
a dialogue recording module, configured to receive text messages from a social media platform, wherein the text message comprises a transmission timestamp, a sender identifier, and message content;
a content processing module, configured to segment the message content into a plurality of semantic units and convert the plurality of semantic units into a new knowledge graph;
a knowledge graph database, configured to store a pre-loaded knowledge graph and the new knowledge graph;
a knowledge retrieval module, configured to query the pre-loaded knowledge graph in the knowledge graph database based on the plurality of semantic units to obtain a relevant knowledge graph; and
a reference data module, configured to generate a reference data message based on the relevant knowledge graph, wherein the reference data message has a correlation with the message content.

2. The intelligent assistant system for supporting social media conversations as claimed in claim 1, wherein the dialogue recording module establishes a connection with the social media platform via an application programming interface and receives the text messages in real-time.

3. The intelligent assistant system for supporting social media conversations as claimed in claim 1, wherein the new knowledge graph is periodically updated to the pre-loaded knowledge graph to expand the content of the pre-loaded knowledge graph.

4. The intelligent assistant system for supporting social media conversations as claimed in claim 1, wherein the reference data module is configured to apply node content and node relation types in the relevant knowledge graph to a response text template to generate the reference data message.

5. The intelligent assistant system for supporting social media conversations as claimed in claim 4, wherein the reference data message comprises at least one of: a relevant information hint, suggested response content, or a historical relevant message.

6. The intelligent assistant system for supporting social media conversations as claimed in claim 1, wherein the correlation between the reference data message and the message content is determined by at least one of the following conditions:
(a) node content in the relevant knowledge graph is similar or identical to node content in the new knowledge graph; or
(b) node relation types in the relevant knowledge graph are similar or identical to node relation types in the new knowledge graph.

7. The intelligent assistant system for supporting social media conversations as claimed in claim 1, further comprising: a report generation module, configured to convert the new knowledge graph into a user-readable text report.

8. A method for supporting social media conversations, comprising the following steps:
receiving text messages from a social media platform, wherein the text message comprises a transmission timestamp, a sender identifier, and message content;
segmenting the message content to obtain a plurality of semantic units, and converting the plurality of semantic units into a new knowledge graph;
storing the new knowledge graph into a knowledge graph database, wherein the knowledge graph database further has a pre-loaded knowledge graph;
querying the pre-loaded knowledge graph in the knowledge graph database based on the plurality of semantic units to obtain a relevant knowledge graph; and
generating a reference data message based on the relevant knowledge graph, wherein the reference data message has a correlation with the message content.

9. The method for supporting social media conversations as claimed in claim 8, wherein the step of receiving text messages comprises:
establishing a connection with the social media platform via an application programming interface and receiving the text messages in real-time.

10. The method for supporting social media conversations as claimed in claim 8, further comprising: periodically updating the new knowledge graph to the pre-loaded knowledge graph to expand the content of the pre-loaded knowledge graph.
